(19) United States
(12) Patent Application Publication
(10) Pub. No.: US 2026/0117780 A1
(43) Pub. Date: Apr. 30, 2026

(54) CENTRIFUGAL FAN

(71) Applicant: DAIKIN INDUSTRIES, LTD., Osaka (JP)

(72) Inventors: Ryusuke OTAGURO, Osaka (JP); Kaname MARUYAMA, Osaka (JP); Zuozhou CHEN, Osaka (JP); Anan TAKADA, Osaka (JP)

(21) Appl. No.: 19/431,027

(22) Filed: Dec. 23, 2025

Related U.S. Application Data
(63) Continuation of application No. PCT/JP2024/023426, filed on Jun. 27, 2024.

(30) Foreign Application Priority Data
Jun. 30, 2023 (JP) 2023-108410

(51) Int. Cl. F04D 17/08; F04D 29/02; F04D 29/66

(52) U.S. Cl. CPC F04D 17/08; F04D 29/023; F04D 29/666

(57) ABSTRACT

A centrifugal fan includes a first member coupled to a rotation shaft, a second member opposed to the first member, and a vane disposed between the first member and the second member. The vane includes a solid portion and a pressure variation reducing portion. The pressure variation reducing portion is disposed on one of a positive pressure surface and a negative pressure surface of the vane. The vane includes a leading edge disposed at a radially inward position and a trailing edge disposed at a radially outward position. The pressure variation reducing portion has an area centroid located closer to the leading edge than to the trailing edge.

### CROSS-REFERENCE TO RELATED APPLICATIONS

This application is a continuation of, and claims the benefit of priority from International Application No. PCT/JP2024/023426, filed on June 27, 2024, which claims the benefit of priority from Japanese Patent Application No. 2023-108410, filed on June 30, 2023, the entire contents of each of which are incorporated herein by reference.

### BACKGROUND

### TECHNICAL FIELD

The present disclosure relates to a centrifugal fan.

Japanese Patent No. 3071287B discloses a technology related to an axial flow fan. In Japanese Patent No. 3071287B, a hollow layer is disposed in a vane of a fan impeller. The entirety or part of the surface of the vane is formed from a porous material that allows the hollow layer to communicate with the exterior to reduce noise.

### SUMMARY

In one general aspect, a centrifugal fan includes a first member coupled to a rotation shaft, a second member opposed to the first member, and a vane disposed between the first member and the second member. The vane includes a solid portion and a pressure variation reducing portion. The pressure variation reducing portion is disposed on one of a positive pressure surface and a negative pressure surface of the vane. The vane includes a leading edge disposed at a radially inward position and a trailing edge disposed at a radially outward position. The pressure variation reducing portion has an area centroid located closer to the leading edge than to the trailing edge.

### BRIEF DESCRIPTION OF DRAWINGS

FIG. 1 is a perspective view showing a first embodiment of a centrifugal fan.

FIG. 2 is a side view of the centrifugal fan shown in FIG. 1.

FIG. 3 is a schematic diagram showing a cross section of a vane of the centrifugal fan shown in FIG. 1.

FIG. 4 is a graph showing the noise reduction effect in accordance with a position of a pressure variation reducing portion on the vane.

FIG. 5 is a schematic diagram showing a cross section of a vane of a centrifugal fan in a second embodiment.

FIG. 6 is a graph showing the noise reduction effect in accordance with the width of a hollow portion.

FIG. 7 is a schematic diagram showing a cross section of a vane of a centrifugal fan in a third embodiment.

FIG. 8 is a graph showing the blowing noise with respect to the air flow rate when the pressure variation reducing portion is disposed on only the positive pressure surface, only the negative pressure surface, or both the positive pressure surface and the negative pressure surface of the vane, and when the pressure variation reducing portion is not disposed on the vane.

FIG. 9 is a schematic diagram showing a cross section of a vane of a centrifugal fan in a first modified example.

FIG. 10 is a schematic diagram showing a cross section of a vane of a centrifugal fan in a second modified example.

### DETAILED DESCRIPTION OF EMBODIMENT(S)

### FIRST EMBODIMENT

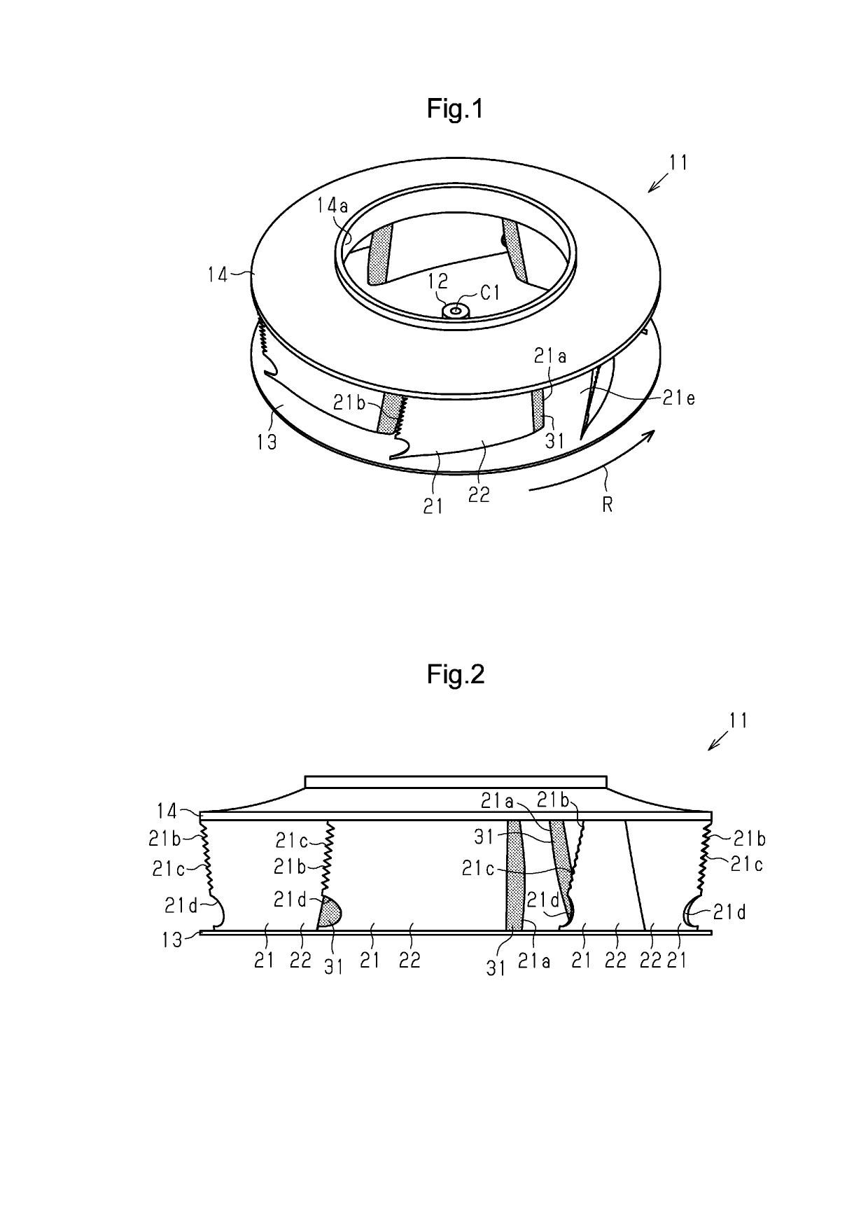

A first embodiment of a centrifugal fan 11 will now be described with reference to FIGS. 1 to 4.

The centrifugal fan 11 is a device that circulates air in a room. The centrifugal fan 11 includes, for example, a turbo fan or a sirocco fan. In the present embodiment, the centrifugal fan 11 will be described as a turbo fan. The centrifugal fan 11 is configured to rotate in a rotation direction R of the centrifugal fan 11 so that air is drawn in from an intake port 14a and is discharged radially outward. The rotation direction R is, for example, a counterclockwise direction. The rotation direction R may be a clockwise direction.

The centrifugal fan 11 is, for example, rotated by a motor. The centrifugal fan 11 includes a rotation shaft 12 that coincides with a rotation shaft of the motor. The rotation shaft 12 has a rotation center axis C1.

The centrifugal fan 11 includes a first member 13 coupled to the rotation shaft 12. The first member 13 rotates integrally with the rotation shaft 12. The first member 13 is, for example, a circular plate. A hole is formed in the center of the first member 13 to receive the rotation shaft 12. The material of the first member 13 is, for example, metal or resin.

The centrifugal fan 11 includes a second member 14 opposed to the first member 13. The second member 14 is, for example, a fan shroud. The second member 14 is, for example, circular. The second member 14 includes a central portion having an intake port 14a that draws air in. The material of the second member 14 is, for example, metal or resin.

The centrifugal fan 11 includes a vane 21 disposed between the first member 13 and the second member 14 in an axial direction of the centrifugal fan 11. Multiple vanes 21 are arranged at a predetermined interval so as to surround the rotation shaft 12 between the first member 13 and the second member 14. The number of vanes 21 is ten or less. Preferably, the number of vanes 21 is six. Alternatively, the number of vanes 21 may be from ten to seven or five to two. The vanes 21 are identical in shape to each other.

Each vane 21 includes a leading edge 21a and a trailing edge 21b. The leading edge 21a is located at the downstream side in the rotation direction R. The leading edge 21a is located toward the rotation shaft 12. The leading edge 21a is located at a radially inner position of the centrifugal fan 11 from the trailing edge 21b. The leading edge 21a is curved downstream in the rotation direction R. In an example, the leading edge 21a includes an axial intermediate portion that projects downstream the most in the rotation direction R.

The trailing edge 21b is located at the upstream side in the rotation direction R. The trailing edge 21b is located at a radially outer position of the centrifugal fan 11 from the leading edge 21a. The trailing edge 21b includes, for example, irregularities 21c and a cutout 21d. The irregularities 21c have the form of, for example, a sawtooth. The irregularities 21c are disposed on the trailing edge 21b near the second member 14. The cutout 21d is disposed on the trailing edge 21b near the first member 13. The irregularities 21c and the cutout 21d may be omitted.

The vane 21 gradually increases in thickness from the trailing edge 21b toward the leading edge 21a. In two of the vanes 21 located circumferentially adjacent to each other, a blow-out port 21e is provided between the leading edge 21a of one of the vanes 21 and the trailing edge 21b of the other one of the vanes 21. When the centrifugal fan 11 rotates in the rotation direction R, air is drawn in from the intake port 14a of the second member 14. The centrifugal fan 11 guides the intake air from the leading edge 21a to the trailing edge 21b of the vane 21 and discharges the air from the blow-out port 21e radially outward from the centrifugal fan 11.

The vane 21 includes a solid portion 22 and a pressure variation reducing portion 31. The solid portion 22 has a high density. The material of the solid portion 22 is not limited. The material of the solid portion 22 is, for example, metal or resin. The solid portion 22 has a greater density than the pressure variation reducing portion 31. Details of the pressure variation reducing portion 31 will be described later.

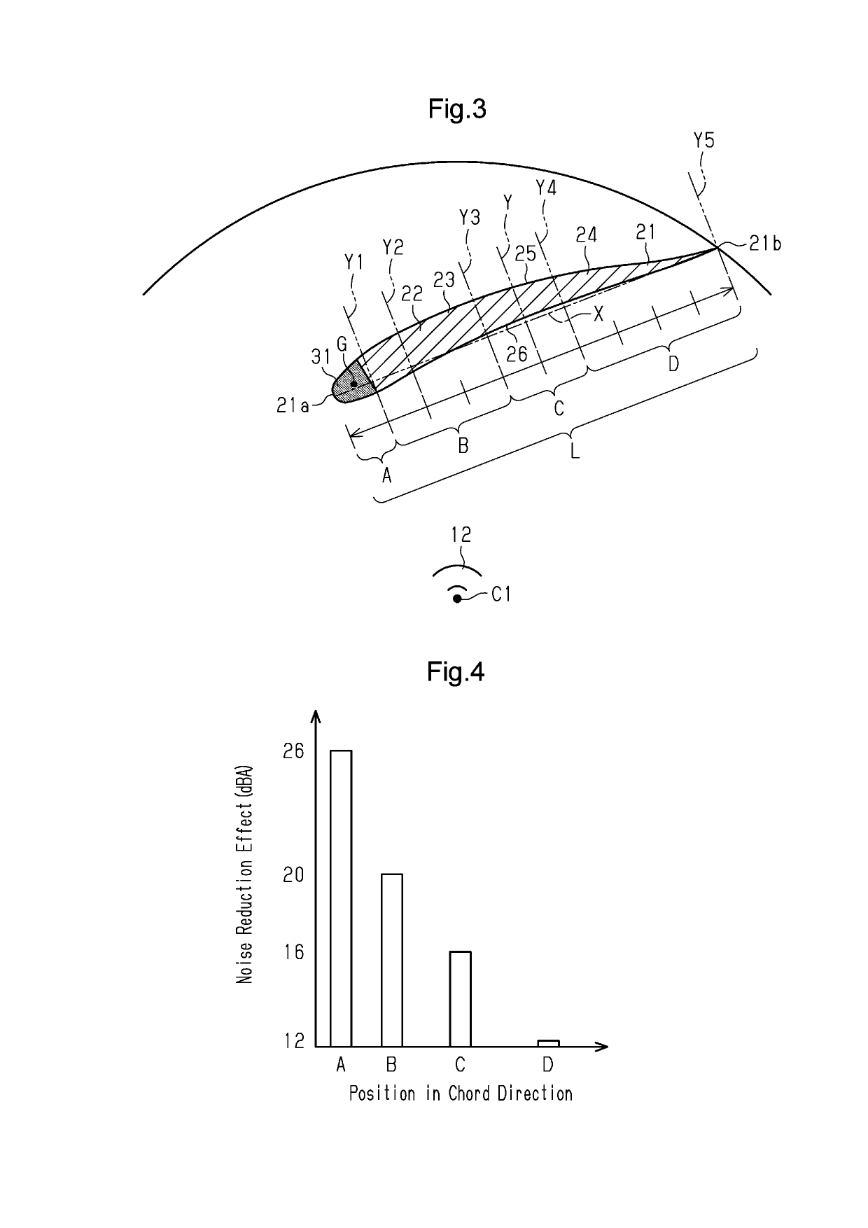

FIG. 3 shows a vane cross section that is orthogonal to the rotation shaft 12. The vane cross section is, for example, a cross section of the vane 21 in a direction orthogonal to the rotation shaft 12. The vane cross section is, for example, a cross section of the vane 21 at an equal distance from the first member 13. In the vane cross section, a line connecting the leading edge 21a and the trailing edge 21b is defined as an imaginary line X. The length of the imaginary line X is defined as a chord length L.

The vane 21 includes a leading portion 23 and a trailing portion 24. The line extending orthogonal to the chord length L through a position at 50% of the chord length L from the leading edge 21a is defined as a center border Y. The leading portion 23 is a portion of the vane 21 located toward the leading edge 21a from the center border Y. The trailing portion 24 is a portion of the vane 21 located toward the trailing edge 21b from the center border Y. The leading portion 23 has a greater width than the trailing portion 24 in a direction orthogonal to the chord length L.

The vane 21 has a positive pressure surface 25 and a negative pressure surface 26. The positive pressure surface 25 is a vane surface adjacent to space where the pressure becomes positive due to flow of air when the centrifugal fan 11 rotates. The negative pressure surface 26 is a vane surface adjacent to space where the pressure becomes negative due to flow of air when the centrifugal fan 11 rotates.

### Pressure Variation Reducing Portion

The pressure variation reducing portion 31 is configured to reduce variations in pressure that occur at the vane 21. The pressure variation reducing portion 31 is, for example, disposed on the leading edge 21a. The pressure variation reducing portion 31 is also disposed on a part of the leading portion 23 differing from the leading edge 21a. The pressure variation reducing portion 31 is formed integrally with the solid portion 22 by insert molding, adhesion, or fitting. In FIGS. 1 to 3, 5, 7, 9, and 10, the pressure variation reducing portion 31 is indicated by dots.

The pressure variation reducing portion 31 is disposed on one of the positive pressure surface 25 and the negative pressure surface 26 of the vane 21. The pressure variation reducing portion 31 is disposed on both the positive pressure surface 25 and the negative pressure surface 26 of the vane 21. The pressure variation reducing portion 31 is disposed to allow for communication between the positive pressure surface 25 and the negative pressure surface 26 of the vane 21. The pressure variation reducing portion 31 may be disposed on only the positive pressure surface 25 of the vane 21 or may be disposed on only the negative pressure surface 26 of the vane 21.

The material of the pressure variation reducing portion 31 is not limited. The material of the pressure variation reducing portion 31 includes, for example, resin, ceramics, and metal. The resin is, for example, foam plastic. The ceramics or metal is, for example, a porous sintered body. The metal may be a net-shaped body, which is also referred to as a mesh.

The pressure variation reducing portion 31 is, for example, formed of a porous material. The porous material allows for communication between the positive pressure surface 25 and the negative pressure surface 26 of the vane 21. The porous material includes pores allowing for communication between the positive pressure surface 25 and the negative pressure surface 26 of the vane 21. When the positive pressure surface 25 and the negative pressure surface 26 of the vane 21 communicate with each other through the pressure variation reducing portion 31 and the centrifugal fan 11 rotates, air is discharged from the pressure variation reducing portion 31 at the side of the positive pressure surface 25. When the positive pressure surface 25 and the negative pressure surface 26 of the vane 21 communicate with each other through the pressure variation reducing portion 31 and the centrifugal fan 11 rotates, air is drawn in from the pressure variation reducing portion 31 at the side of the negative pressure surface 26.

The pressure variation reducing portion 31 has an area centroid G. The area centroid G is the center of gravity of a cross section of the pressure variation reducing portion 31 when the specific gravity of the pressure variation reducing portion 31 is uniform. The area centroid G of the pressure variation reducing portion 31 is located closer to the leading edge 21a than to the trailing edge 21b.

In the imaginary line X, a line extending orthogonal to the imaginary line X through a position at 10% of the chord length L from the leading edge 21a is defined as a first border Y1. In the imaginary line X, a line extending orthogonal to the imaginary line X through a position at 20% of the chord length L from the leading edge 21a is defined as a second border Y2. In the imaginary line X, a line extending orthogonal to the imaginary line X through a position at 40% of the chord length L from the leading edge 21a is defined as a third border Y3. In the imaginary line X, a line extending orthogonal to the imaginary line X through a position at 60% of the chord length L from the leading edge 21a is defined as a fourth border Y4. In the imaginary line X, a line extending orthogonal to the imaginary line X through a position at 100% of the chord length L from the leading edge 21a is defined as a fifth border Y5.

The area centroid G is located within 40% of the chord length L from the leading edge 21a. More specifically, the area centroid G is located in a region of the vane cross section toward the leading edge 21a from the third border Y3. Preferably, the area centroid G is located within 20% of the chord length L from the leading edge 21a. More specifically, the area centroid G is located in a region of the vane cross section toward the leading edge 21a from the second border Y2.

FIG. 4 shows an example of the noise reduction effect obtained in accordance with the region where the pressure variation reducing portion 31 is disposed in a chord direction extending along the imaginary line X. As shown in FIG. 3, region A is defined between the leading edge 21a and the first border Y1. Region B is defined between the first border Y1 and the third border Y3. Region C is defined between the third border Y3 and the fourth border Y4. Region D is defined between the fourth border Y4 and the fifth border Y5.

When the pressure variation reducing portion 31 is disposed in the region A, the noise reduction effect is greater than when the pressure variation reducing portion 31 is disposed in the regions B to D. When the pressure variation reducing portion 31 is disposed in the region B, the noise reduction effect is greater than when the pressure variation reducing portion 31 is disposed in the regions C and D. When the pressure variation reducing portion 31 is disposed in the region C, the noise reduction effect is greater than when the pressure variation reducing portion 31 is disposed in the region D.

### Advantages of the First Embodiment

The advantages of the first embodiment will now be described.

(1-1)

The centrifugal fan 11 includes the first member 13 coupled to the rotation shaft 12, the second member 14 opposed to the first member 13, and the vane 21 disposed between the first member (13) and the second member (14). The vane 21 includes the solid portion 22 and the pressure variation reducing portion 31. The pressure variation reducing portion 31 is disposed on one of the positive pressure surface 25 and the negative pressure surface 26 of the vane 21. The vane 21 includes the leading edge 21a located at a radially inner position and the trailing edge 21b located at a radially outer position. The area centroid G of the pressure variation reducing portion 31 is located closer to the leading edge 21a than to the trailing edge 21b.

In this structure, the pressure variation reducing portion 31 is disposed on the vane 21 of the centrifugal fan 11 to eliminate variations in pressure, which cause noise, from the vicinity of the vane surface. Thus, development of a vortex in the vicinity of the vane surface is limited. This reduces noise caused by turbulence of a vortex interfering with the vane 21. Therefore, the centrifugal fan 11 reduces noise in a preferred manner.

In the centrifugal fan 11, the portion of the vane 21 located near the trailing edge 21b is smaller in thickness than the portion of the vane 21 located near the leading edge 21a. Therefore, the portion located near the trailing edge 21b is less strong and less rigid than the portion located near the leading edge 21a. Hence, the portion of the vane 21 located near the trailing edge 21b deforms more readily than the portion of the vane 21 located near the leading edge 21a. In particular, in a turbo fan, pressure increase with respect to the air flow rate is large, so that the vane 21 receives a large load. If the pressure variation reducing portion 31, which is less strong and less rigid than the solid portion 22, is disposed on the trailing edge 21b, adverse effects resulting from deformation of the vane 21 are more significant than the noise reduction effect. The centrifugal fan 11, in which the pressure variation reducing portion 31 is disposed on the portion of the vane 21 located near the leading edge 21a, reduces noise in a preferred manner. (1-2)

In the vane cross section orthogonal to the rotation shaft 12, the length of a line connecting the leading edge 21a and the trailing edge 21b is referred to as the chord length L, and the area centroid G is located within 40% of the chord length L from the leading edge 21a.

With this structure, noise caused by turbulence of a vortex interfering with the vane 21 is reduced as compared with a structure in which the area centroid G is located at a position over 40% of the chord length L from the leading edge 21a. (1-3)

The area centroid G is located within 20% of the chord length L from the leading edge 21a.

With this structure, noise caused by turbulence of a vortex interfering with the vane 21 is reduced as compared with a structure in which the area centroid G is located at a position over 20% of the chord length L from the leading edge 21a. (1-3)

The pressure variation reducing portion 31 is disposed on the leading edge 21a.

With this structure, in which the pressure variation reducing portion 31 is disposed on the leading edge 21a, noise caused by turbulence of a vortex interfering with the vane 21 is reduced as compared with a structure in which the pressure variation reducing portion 31 is not disposed on the leading edge 21a. (1-4)

The pressure variation reducing portion 31 is disposed to allow for communication between the positive pressure surface 25 and the negative pressure surface 26.

With this structure, in which the positive pressure surface 25 communicates with the negative pressure surface 26, variations in pressure caused by turbulence of air flow are sufficiently reduced. Thus, noise caused by turbulence of a vortex interfering with the vane 21 is reduced. (1-5)

The pressure variation reducing portion 31 is formed of a porous material.

In this structure, air flows through the porous material. This eliminates variations in pressure, which cause noise, from the vicinity of the vane surface. Thus, development of a vortex in the vicinity of the vane surface is limited. This reduces noise caused by turbulence of a vortex interfering with the vane 21.

### SECOND EMBODIMENT

A second embodiment of a centrifugal fan will now be described with reference to FIGS. 1, 2, 5, and 6. In the second embodiment, the differences from the first embodiment will be described. The same reference names are given to those elements that are the same as the corresponding elements of the first embodiment. Such elements will not be described in detail.

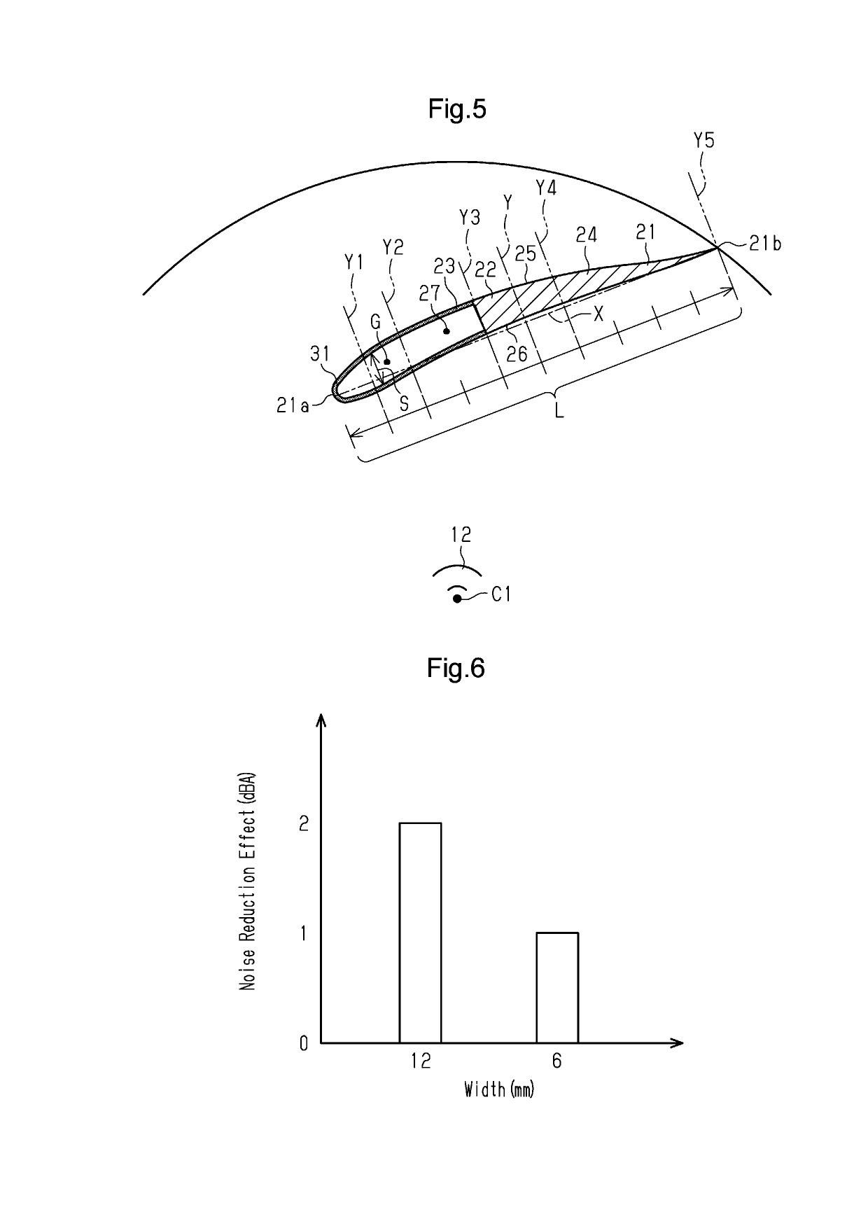

As shown in FIG. 5, the vane 21 further includes a hollow portion 27. The hollow portion 27 is adjacent to the pressure variation reducing portion 31. The pressure variation reducing portion 31 is adjacent to the hollow portion 27 so as to surround the hollow portion 27.

The hollow portion 27 is disposed on the leading portion 23 of the vane 21. The pressure variation reducing portion 31 allows the hollow portion 27 to communicate with the positive pressure surface 25 and the negative pressure surface 26. The pressure variation reducing portion 31 may allow the hollow portion 27 to communicate with only the positive pressure surface 25. The pressure variation reducing portion 31 may allow the hollow portion 27 to communicate with only the negative pressure surface 26.

The hollow portion 27 is adjacent to the solid portion 22 in the chord direction extending along the imaginary line X. The solid portion 22 includes a part disposed on the trailing portion 24. The solid portion 22 may include a part disposed on the leading portion 23.

The area centroid G is located in the hollow portion 27 in the vane cross section. The hollow portion 27 has a width S in a direction orthogonal to the chord length L. The maximum width of the hollow portion 27 is greater than or equal to 12 mm.

FIG. 6 shows an example of the noise reduction effect obtained in accordance with the width S. When the width S is greater than or equal to 12 mm, the noise reduction effect is greater than when the width S is less than 12 mm. When the width S is greater than or equal to 12 mm, the noise reduction effect increases as the width S increases. In an example, when the width S is 12 mm, the noise reduction effect is greater than when the width S is 6 mm.

### Advantages of the Second Embodiment

The advantages of the second embodiment will now be described. The second embodiment has the following advantages in addition to the advantages of the first embodiment. (2-1)

The vane 21 further includes the hollow portion 27. The hollow portion 27 is adjacent to the pressure variation reducing portion 31.

This structure allows for passage of air flow from the vicinity of the vane surface toward the inside of the vane, which is located away from the vane surface. Thus, variations in pressure caused by turbulence of the air flow generated in the vicinity of the vane surface are reduced. Accordingly, noise caused by turbulence of vortex interfering with the vane 21 is reduced. (2-2)

The hollow portion 27 has a width S in a direction orthogonal to the chord length L, which is the length of the line connecting the leading edge 21a and the trailing edge 21b. The maximum width of the hollow portion 27 is greater than or equal to 12 mm.

This structure allows for passage of air flow from the vicinity of the vane surface toward the inside of the vane, which is located away from the vane surface. Thus, variations in pressure caused by turbulence of the air flow generated at the vane surface are reduced. Accordingly, noise caused by turbulence of vortex interfering with the vane 21 is reduced. In addition, when the width S is greater than or equal to 12 mm, the noise reduction effect is further increased.

### THIRD EMBODIMENT

A third embodiment of a centrifugal fan will now be described with reference to FIGS. 1, 2, 7, and 8. In the third embodiment, differences from the first and second embodiments will be described. The same reference names are given to those elements that are the same as the corresponding elements of the first and second embodiments, and such elements will not be described in detail.

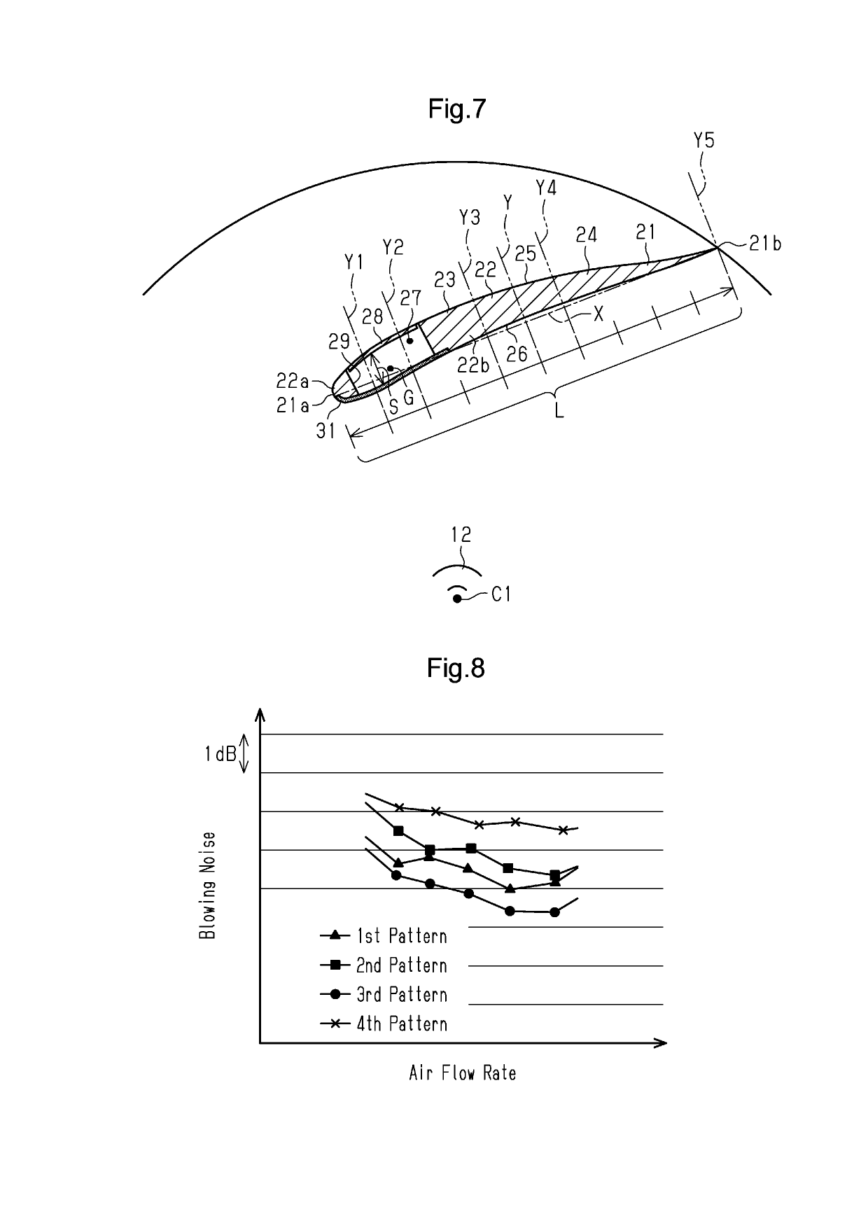

As shown in FIG. 7, the vane 21 includes a hollow portion 27. The hollow portion 27 is adjacent to the pressure variation reducing portion 31. The hollow portion 27 is disposed on the leading portion 23 of the vane 21.

The pressure variation reducing portion 31 is disposed on only the negative pressure surface 26. The pressure variation reducing portion 31 allows the hollow portion 27 to communicate with only the negative pressure surface 26.

The solid portion 22 includes a first solid part 22a and a second solid part 22b. The first solid part 22a is disposed on the leading edge 21a. The second solid part 22b is disposed on the trailing portion 24. The second solid part 22b is partially disposed on the leading portion 23. The hollow portion 27 is adjacent to the first solid part 22a and the second solid part 22b. The hollow portion 27 is disposed between the first solid part 22a and the second solid part 22b in the chord direction extending along the imaginary line X.

The vane 21 further includes a cover 28. The solid portion 22 includes the cover 28. The cover 28 is disposed between the first solid part 22a and the second solid part 22b in the chord direction extending along the imaginary line X. The cover 28 is disposed on the positive pressure surface 25. The cover 28 is configured to cover a concave portion 29 in the vane 21. The hollow portion 27 is formed when the cover 28 covers the concave portion 29.

The pressure variation reducing portion 31 may be disposed between the cover 28 and the first solid part 22a. When the pressure variation reducing portion 31 is disposed between the cover 28 and the first solid part 22a, the pressure variation reducing portion 31 is, for example, a gap between the cover 28 and the first solid part 22a. The pressure variation reducing portion 31 may be disposed between the cover 28 and the second solid part 22b. When the pressure variation reducing portion 31 is disposed between the cover 28 and the second solid part 22b, the pressure variation reducing portion 31 is, for example, a gap between the cover 28 and the second solid part 22b.

The pressure variation reducing portion 31 may include the cover 28. When the pressure variation reducing portion 31 includes the cover 28, the cover 28 is formed of a porous material.

The area centroid G is located in the hollow portion 27 in the vane cross section. The hollow portion 27 has a width S in a direction orthogonal to the chord length L. The maximum width of the hollow portion 27 is greater than or equal to 12 mm.

FIG. 8 is a graph showing the blowing noise with respect to the air flow rate in a first pattern, a second pattern, a third pattern, and a fourth pattern. In the first pattern, the pressure variation reducing portion 31 is disposed on only the negative pressure surface 26. In the second pattern, the pressure variation reducing portion 31 is disposed on only the positive pressure surface 25. In the third pattern, the pressure variation reducing portion 31 is disposed on the positive pressure surface 25 and the negative pressure surface 26. In the fourth pattern, the pressure variation reducing portion 31 is not disposed on the vane 21.

In the third pattern, the blowing noise with respect to the air flow rate is smaller than in the first, second, and fourth patterns. In the first pattern, the blowing noise with respect to the air flow rate is smaller than in the second and fourth patterns. In the second pattern, the blowing noise with respect to the air flow rate is smaller than in the fourth pattern.

According to FIG. 8, when the pressure variation reducing portion 31 is disposed on the positive pressure surface 25 or the negative pressure surface 26, the noise reduction effect is greater than when the pressure variation reducing portion 31 is not disposed on the vane 21. In addition, when the pressure variation reducing portion 31 is disposed on the negative pressure surface 26, the noise reduction effect is greater than when the pressure variation reducing portion 31 is disposed on the positive pressure surface 25.

### Advantages of the Third Embodiment

The advantages of the third embodiment will now be described. The third embodiment has the following advantages in addition to the advantages of the first and second embodiments. (3-1)

The solid portion 22 is disposed on the leading edge 21a.

This structure, in which the solid portion 22 is disposed on the leading edge 21a, increases the strength and rigidity of the vane 21. (3-2)

The pressure variation reducing portion 31 is disposed on only the negative pressure surface 26.

This structure, in which the pressure variation reducing portion 31 is disposed on only the negative pressure surface 26, reduces costs and noise caused by turbulence of a vortex interfering with the vane 21. (3-3)

The vane 21 further includes the cover 28 and the concave portion 29.

The hollow portion 27 is defined by the cover 28 and the concave portion 29.

With this structure, the vane 21 is divided into the cover 28 and the solid portion 22. The cover 28 and the solid portion 22 are coupled to form the hollow portion 27 in a preferred manner.

### Modified Examples

In addition to the embodiments described above, the centrifugal fan 11 according to the present disclosure may be, for example, applicable to modified examples that are described below and combinations of at least two of the modified examples that do not contradict each other.

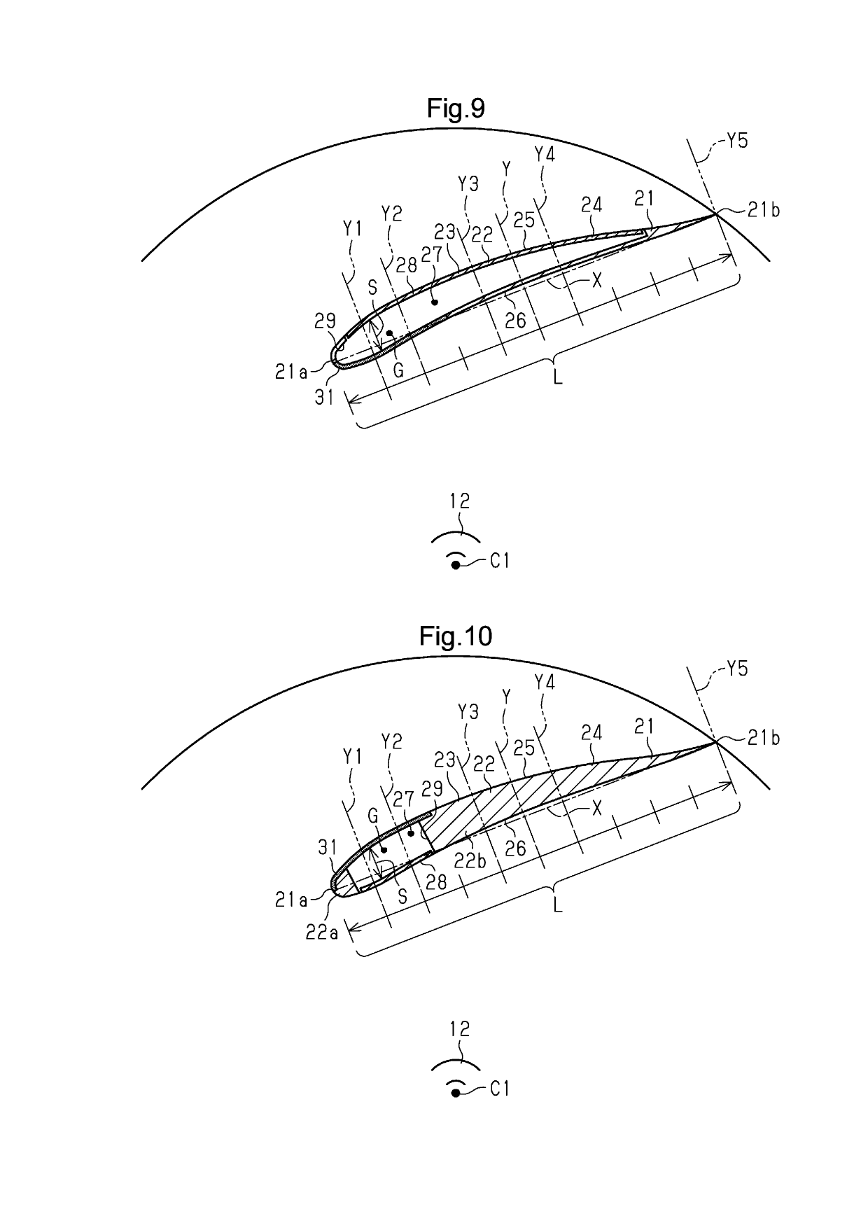

As shown in FIG. 9, the vane 21 may be hollow, and the pressure variation reducing portion 31 may be disposed on only the negative pressure surface 26. In this case, the solid portion 22 and the pressure variation reducing portion 31 are configured to surround the hollow portion 27. When the vane 21 is hollow, the pressure variation reducing portion 31 may be disposed on only the positive pressure surface 25. When the vane 21 is hollow, the cover 28 covers the concave portion 29 to form the hollow portion 27.

As shown in FIG. 10, the pressure variation reducing portion 31 may be disposed on only the positive pressure surface 25. When the pressure variation reducing portion 31 is disposed on the positive pressure surface 25, the pressure variation reducing portion 31 allows the hollow portion 27 to communicate with only the positive pressure surface 25.

While the embodiments of the centrifugal fan 11 have been described above, it is to be appreciated that various changes in form and detail may be made without departing from the spirit and scope of the centrifugal fan 11 presently or hereafter claimed.

1. A centrifugal fan, comprising:
a first member coupled to a rotation shaft;
a second member opposed to the first member; and
a vane disposed between the first member and the second member,
the vane including a solid portion and a pressure variation reducing portion,
the pressure variation reducing portion being disposed on one of a positive pressure surface and a negative pressure surface of the vane,
the vane including a leading edge disposed at a radially inward position and a trailing edge disposed at a radially outward position, and
the pressure variation reducing portion having an area centroid located closer to the leading edge than to the trailing edge.

2. The centrifugal fan according to claim 1, wherein
in a vane cross section that is orthogonal to the rotation shaft, a length of a line connecting the leading edge and the trailing edge is a chord length, and the area centroid is located within 40% of the chord length from the leading edge.

3. The centrifugal fan according to claim 2, wherein
the area centroid is located within 20% of the chord length from the leading edge.

4. The centrifugal fan according to claim 1, wherein
the solid portion is disposed on the leading edge.

5. The centrifugal fan according to claim 1, wherein
the pressure variation reducing portion is disposed on the leading edge.

6. The centrifugal fan according to claim 1, wherein
the pressure variation reducing portion is disposed to allow for communication between the positive pressure surface and the negative pressure surface.

7. The centrifugal fan according to claim 1, wherein
the pressure variation reducing portion is disposed on only the negative pressure surface.

8. The centrifugal fan according to claim 1, wherein
the vane further includes a hollow portion, and
the hollow portion is adjacent to the pressure variation reducing portion.

9. The centrifugal fan according to claim 8, wherein
a length of a line connecting the leading edge and the trailing edge is a chord length,
the hollow portion has a width in a direction orthogonal to the chord length, and
the hollow portion has a maximum width that is greater than or equal to 12 mm.

10. The centrifugal fan according to claim 1, wherein
the pressure variation reducing portion is formed of a porous material.
